(19) United States
(12) Patent Application Publication
(10) Pub. No.: US 2014/0244993 A1
(43) Pub. Date: Aug. 28, 2014

(54) METHOD OF UPDATING THE OPERATING SYSTEM OF A SECURE MICROCIRCUIT

(71) Applicant: INSIDE SECURE, Meyreuil (FR)

(72) Inventor: Gary CHEW, Aix En Provence (FR)

(73) Assignee: INSIDE SECURE, Meyreuil (FR)

(21) Appl. No.: 14/192,114

(22) Filed: Feb. 27, 2014

(30) Foreign Application Priority Data
Feb. 27, 2013 (FR) 13 51727

(51) Int. Cl. G06F 21/57; G06F 9/44; H04L 9/32

(52) U.S. Cl. CPC G06F 21/575; H04L 9/32; G06F 9/4406
USPC 713/2

(57) ABSTRACT

A method of loading an operating program in a secure microcircuit, includes the steps of: downloading and installing in the microcircuit a boot program, which is launched upon activation of the microcircuit, loading into the microcircuit initialization data including a first public key, performing a mutual authentication procedure between the microcircuit and a first server having a private key corresponding to the first public key, and if the mutual authentication is successful, loading from the first server operating program profile data holding a second public key, performing a mutual authentication procedure between the microcircuit and a second server having a private key corresponding to the second public key, and if the mutual authentication is successful, loading an operating program from the second server and installing it in the microcircuit, and activating the operating program when it is in the microcircuit.

### FIELD

The present invention relates to secure microcircuits such as those embedded in smart cards, and to portable items such as mobile phones and digital tablets, incorporating such smart cards.

The present invention applies in particular to contact smart cards or NFC (Near Field Communication) smart cards that secure sensitive transactions such as payment transactions or accesses to a service.

### BACKGROUND

Smart card microcircuits generally include a processor, volatile memory and a rewritable non-volatile memory for storing programs executed by the processor and data specific to the system and to the user of the smart card, as well as other data to be retained between two transactions. Programs executed by the processor typically include an operating system or program and application programs.

For security reasons, the loading of the operating program in the non-volatile memory of the microcircuit is typically performed by the manufacturer of the microcircuit. The entire microcircuit and its operating program are generally certified by a very restrictive certification procedure, in order to authorize the microcircuit thereafter to conduct sensitive transactions such as payment transactions. Traditionally, the life cycle of a secure microcircuit comprises the steps of separate hardware certification of the microcircuit and software certification of the operating program to be installed in the microcircuit. Once the microcircuit is manufactured, the manufacturer of the microcircuit inserts in the non-volatile memory of the microcircuit a unique identifier that may be a serial number, keys specific to the microcircuit, a public key of the distributor of the microcircuit, and the operating program with associated data. All these data and the operating program may be stored in a rewritable memory of the microcircuit. After undergoing a number of tests, the microcircuit is delivered by the manufacturer to the distributor. The manufacturer and/or distributor may install applications in the microcircuit respecting a certain procedure involving authentication of each application and of a server providing the application for the microcircuit, the application having been previously certified by a dedicated certification entity. The distributor then controls the distribution of the microcircuit to end-users and manages the life cycle of the microcircuit.

Once the microcircuit and the installed operating program are certified as a whole, it is no longer possible to change the operating program without subjecting both to a new certification procedure. However, a need to change the operating program of a secure microcircuit may arise, especially so that microcircuits already in service may benefit from updates to the operating program, or may receive a new operating program, issued for example by another entity.

### SUMMARY

Embodiments relate to a method of loading an operating program in a secure microcircuit, comprising the steps of: downloading and installing in the microcircuit a boot program, which is launched upon activation of the microcircuit, loading into the microcircuit initialization data including a first public key, performing a mutual authentication procedure between the microcircuit and a first server having a private key corresponding to the first public key, and if the mutual authentication is successful, loading from the first server operating program profile data holding a second public key, performing a mutual authentication procedure between the microcircuit and a second server having a private key corresponding to the second public key, and if the mutual authentication is successful, loading an operating program from the second server and installing it in the microcircuit, and activating the operating program when it is in the microcircuit.

According to an embodiment, the method comprises the steps of: performing a mutual authentication procedure between the microcircuit and a third server having a private key corresponding to a third public key held in the operating program profile data, and if the mutual authentication procedure is successful, loading an application from the third server and installing it in the microcircuit, and/or loading user data in the microcircuit.

According to an embodiment, the method comprises the steps of: performing a mutual authentication procedure between the microcircuit and a third server having a private key corresponding to a third public key held in the operating program profile data, and if the mutual authentication procedure is successful, running a command for erasing the operating program and operating program profile data in the microcircuit, wherein the erase command is transmitted to the microcircuit from the third server, and placing the microcircuit in a state where it is ready to receive new operating program profile data from the first server.

According to an embodiment, the operating program profile data and/or the operating program are transmitted in encrypted form using a secret key shared between the microcircuit and the first and/or second server during mutual authentication.

According to an embodiment, the method comprises a step of receiving by the microcircuit a signal for enabling a control mode wherein the microcircuit can receive commands from a server, including an operating program erase command.

According to an embodiment, the activation signal of the control mode includes a sequence of several reset signals received during a period of time.

According to an embodiment, the method comprises a step of checking the integrity of the boot program upon start-up of the microcircuit.

According to an embodiment, the installation of the operating program in the microcircuit is followed by an integrity check of the installed operating program, wherein the operating program is erased from the microcircuit if the integrity check fails.

Embodiments also relate to a secure microcircuit configured by a boot program for: loading into the microcircuit initialization data comprising a first public key, performing a mutual authentication procedure between the microcircuit and a first server having a private key corresponding to the first public key, and if the mutual authentication is successful, loading from the first server operating program profile data holding a second public key, and performing a mutual authentication procedure between the microcircuit and a second server having a private key corresponding to the second public key, and if the mutual authentication is successful, loading an operating program from the second server and installing it in the microcircuit, and activating the operating program when it is in the microcircuit.

According to an embodiment, the microcircuit is configured by the operating program for: performing a mutual authentication procedure between the microcircuit and a third server having a private key corresponding to a third public key held in the operating program profile data, and if the mutual authentication is successful, receiving an application from the third server and installing it in the microcircuit, and/or loading user data in the microcircuit.

According to an embodiment, the microcircuit is configured by the boot program for: performing a mutual authentication procedure between the microcircuit and a third server having a private key corresponding to a third public key held in the operating program profile data, and if the mutual authentication is successful, receiving from the third server and executing a command for erasing the operating program and the operating program profile data from the microcircuit, and placing the microcircuit in a state where it is ready to receive new operating program profile data from the first server.

According to an embodiment, the microcircuit is configured by the boot program for receiving a signal for enabling a control mode, wherein the microcircuit can receive commands from a server, including an operating program erase command.

According to an embodiment, the control mode enable signal includes a sequence of a number of reset signals received during a period of time.

According to an embodiment, the microcircuit is configured by the boot program to control the integrity of the boot program at start-up of the microcircuit.

According to an embodiment, the microcircuit is configured by the boot program to control the integrity of the operating program once it is installed, and to erase the operating program from the microcircuit if the integrity check fails.

### BRIEF DESCRIPTION OF DRAWINGS

Other advantages and features will become more clearly apparent from the following description of particular embodiments of the invention provided for exemplary purposes only and represented in the appended drawings, in which:

FIG. 1 schematically shows a secure microcircuit,

FIG. 2 is a state diagram of the microcircuit of FIG. 1, according to one embodiment,

FIG. 3 is a sequence of steps performed upon starting the microcircuit of FIG. 1, according to one embodiment,

FIGS. 4A to 4E schematically show the content of non-volatile memories of the secure microcircuit at different states of the microcircuit of FIG. 1, according to one embodiment,

FIG. 5 shows mutual authentication steps of a server and the microcircuit of FIG. 1, according to one embodiment,

FIG. 6 shows steps performed by the microcircuit and different servers that may be authenticated by the microcircuit.

### DESCRIPTION OF EMBODIMENTS

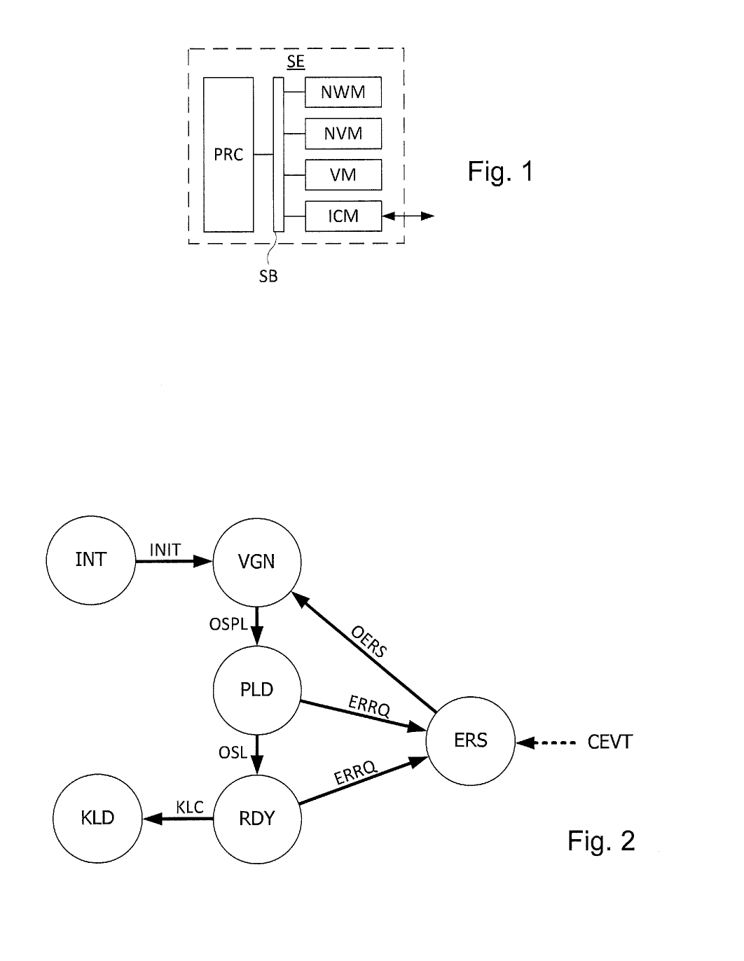

FIG. 1 shows a secure microcircuit SE. The microcircuit SE includes a processor PRC, memories NWM, VM, NVM, communication circuits ICM, and a bus SB connecting the processor PRC to the memories NWM, NVM, VM and circuits ICM. The memories include a volatile memory VM (of RAM type), and one or more non-volatile memories NWM, NVM. The non-volatile memories include a rewritable memory NVM (of flash or EEPROM type) and possibly a write-once memory NWM (of ROM type). The circuits ICM may include contact and/or contactless communication circuits.

FIG. 2 shows a state diagram of a boot program SBL for loading a secure operating system or program. The program SBL is installed in the NVM or NWM memory of the microcircuit during manufacture thereof. The program SBL namely includes cryptographic functions provided to secure the loading of such an operating program and associated data, and authenticate a vendor entity of the operating program, and communication functions exploiting the circuits ICM, designed to communicate with an entity that may provide an operating program and associated data.

At the output of the production line, and upon starting the program SBL, the microcircuit SE is in an initial state INT identified by a state variable stored in the memory NVM or in a register. In this state, the non-volatile memories NVM, NWM of the microcircuit SE contain no data specific to the microcircuit SE. The receipt of an initialization signal triggers an initialization sequence. After this initialization sequence, the microcircuit SE assumes a blank condition VGN. The initialization sequence introduces into the non-volatile memories NVM, NWM initialization data such as a unique identifier SEID for identifying the microcircuit, a pair of private and public keys SESK, SEPK, a public key of a server authorized to load profile data of an operating program in the memory NVM, and possibly an address to access this server. The state variable of the microcircuit SE assumes state VGN. The initialization date of the microcircuit may also be stored. In state VGN, the memories NVM, NWM of the microcircuit SE therefore contain no data relative to an operating system or of an end distributor entity of the microcircuit. In state VGN, the program SBL may assume a preloaded state PLD after receiving profile data OSPL of an operating program OS. The profile data comprise the size of the OS program to be subsequently transmitted to the microcircuit SE, a memory start address for installing the OS program, a memory start address for writing the OS program data, a public key, and possibly an access address of the vendor of the OS program, a name and a checksum of the OS program. The profile data may also include a date of installation of the OS program and a validity date. In the PLD state, the SBL program may assume a state ERS for erasing the OS program and the associated profile data OSPL, upon receipt of an erase request ERRQ received by the microcircuit, or a ready state RDY that may be achieved when an OS program and associated data OSPL are successfully loaded and installed in the NVM memory of the microcircuit SE. In the RDY state, the SBL program may assume the ERS state after receiving an erase request ERRQ or a disabled state KLD. The ERS state may also be assumed upon receipt by the microcircuit SE of a signal relative to a critical event CEVT. In the ERS state, the SBL program erases the OS program and associated profile data OSPL in the NVM memory. At the end of the erase procedure, the microcircuit SE returns to state VGN.

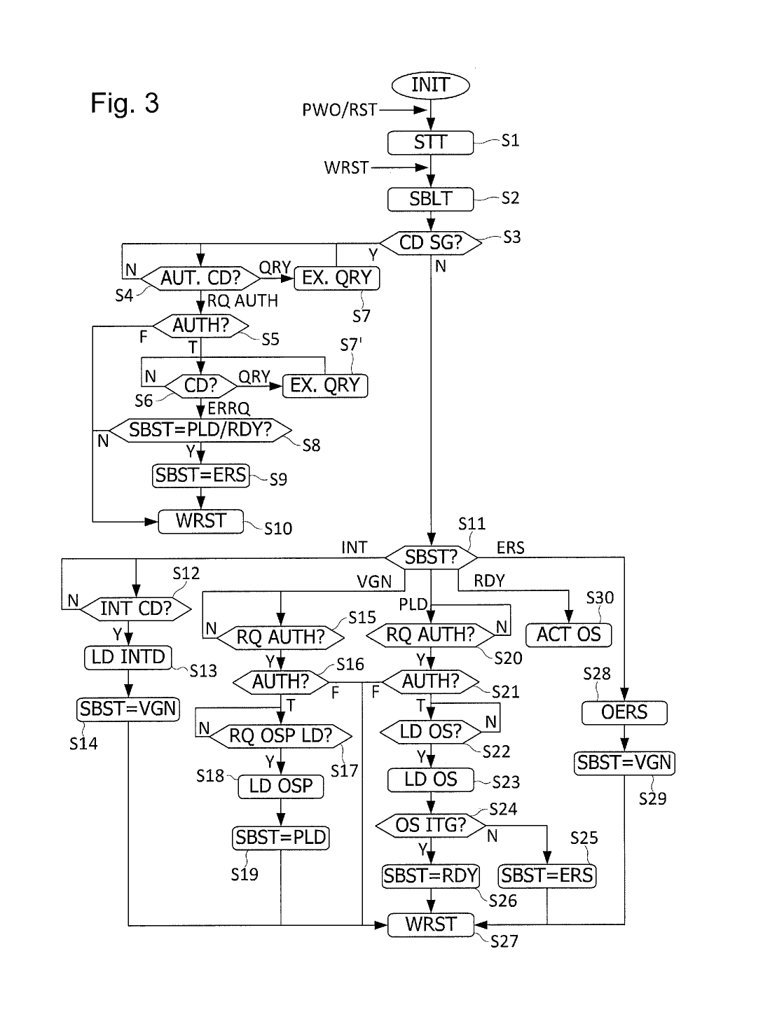

FIG. 3 shows steps performed by the processor PRC under the control of the SBL program. At power-on PWO or following the activation of a cold boot signal RST, the processor PRC executes steps S1 to S5. In step S1, the processor PRC performs power-on tests and enables its ICM interface circuit. In step S2, the processor tests the integrity of the SBL program, for example by calculating a checksum from the SBL program and the associated data stored in the memories NWM and/or NVM or loaded into the VM memory. The S1 step is executed only at power-on PWO of processor PRC or as a result of the activation of a boot signal RST. In contrast, the step S2 is executed directly upon activation of a reset or reboot signal WRST while the processor PRC is powered. In step S3, the processor PRC determines whether it has received a signal for assuming a control mode. If the processor PRC has received such a signal, it assumes a state where it may receive and process orders from outside the microcircuit SE (steps S4 to S10), otherwise it performs some of the steps S11 to S30. The control mode switch signal may be a warm boot signal combined with another signal provided to the processor PRC. The control mode switch signal may also be a sequence of a specified number of warm boot signals received for a specified time. The warm boot signal sequence may be set by initialization parameters of the microcircuit SE.

In step S4, the processor PRC waits for an authorized command. In step S4, the processor PRC may only process an authentication request or a command to read non-confidential data, from the interface circuit ICM. If the received command is an authentication request RQ AUTH, the processor PRC executes step S5 to launch a mutual authentication procedure with the sender of the request. If the received command is a non-confidential data read command, the processor PRC executes step S7. In step S5, if the mutual authentication is completed without error, the processor PRC executes step S6, otherwise it executes step S10 where the processor PRC activates the WRST signal, which causes the SBL program to run again in step S2. Several authentication failures in step S5 may be designed to trigger the signal CEVT for switching program OS into the erase state ERS. In step S7, the processor PRC executes the read command and returns to step S4. In step S6, the processor PRC waits for a command from circuit ICM. At this stage, the processor PRC may handle a command ERRQ to wipe the program OS installed in memory NVM, or a command for reading data that may be confidential.

If the command received in step S6 is a command for reading data, the processor executes step S7′ for reading the data and returns to step S6. If the command received in step S6 is an erase command ERRQ, the processor PRC executes step S8. In this step, the processor checks if the current state SBST of the microcircuit SE is compatible with the execution of the ERRQ command, that is to say, if the state SBST is RDY or PLD (according to the state diagram of FIG. 3). If the state of microcircuit SE is not compatible with the execution of an erase command ERRQ, the processor PRC executes step S10 where it triggers the emission of a warm boot signal WRST (to return to step S2). Otherwise, the processor PRC executes the steps S9 and S10. In step S9, the processor PRC changes the state SBST of microcircuit SE to switch it to state ERS (according to the state diagram of FIG. 3).

In step S11, the processor PRC tests the SBST state of microcircuit SE. If the SBST state is INT, the processor executes the steps S12 to S14. If the SBST state is VGN, it executes the steps S15 to S19. If the SBST state is PLD, it executes the steps S20 to S27. If the SBST state is RDY, it executes step S30 where it activates the program OS previously installed in steps S17 to S29. If the SBST state is ERS, it executes the steps S28 and S29.

In step S12, the processor PRC waits for an initialization command from the ICM circuit. When the initialization command is received, the processor performs the steps S13, S14 and S27 corresponding to the transition between states INT and VGN. Access to step S12 may be protected by an optionally encrypted password, which is written in the memory NVM during the manufacture of the microcircuit. At step S13, the processor PRC loads initialization data transmitted with the received command in the memory NVM. In step S14, the processor sets the SBST state of microcircuit SE to VGN. At step S27, the processor PRC activates the WRST signal, thereby reactivating the SBL program in step S2.

At step S15, the microcircuit is in the VGN state, the processor PRC waits for an authentication request received by the interface circuit ICM. At step S16, the processor executes a mutual authentication procedure with a server in communication with the microcircuit SE. If the authentication procedure fails, the processor PRC directly executes the step S27, otherwise it executes the steps S17 to S19, then S27. At step S17, the processor PRC waits for a command to load profile data of an operating program OSPL. When this command is received, the processor loads the received data (step S18). At step S19, the processor PRC changes the state SBST of the microcircuit to PLD.

In step S20, the microcircuit SE being in state PLD, the processor PRC waits for an authentication request RQ AUTH received by the interface circuit ICM. In step S21, the processor executes the mutual authentication procedure with a server in communication with the microcircuit SE. If the authentication procedure fails, the processor PRC executes step S27, otherwise it executes the steps S22 to S24. In step S22, the processor PRC waits for a first message for downloading an operating program OS. At step S23, it executes a procedure for loading and installing the OS program. In step S24, it executes a procedure for verifying the integrity of the loaded and installed program OS, for example, by calculating a checksum and comparing the value obtained with an expected value. If the verification of the installed OS program fails, the processor executes step S25 where it sets the state SBST of the microcircuit SE to ERS, otherwise it executes step S24 where it sets the state to RDY. Following the steps S24 and S25, the processor PRC executes the step S27 to reactivate the procedure from step S2.

In step S28, with the microcircuit SE in state ERS, the processor PRC executes the command ERRQ to erase the OS program. Then, the processor executes the steps S29 and S27, where it sets the state SBST of microcircuit SE to VGN and activates the signal WRST.

In the RDY state in step S11 (following receipt of the signal WRST), the processor PRC starts executing the OS program. At its first activation, the OS program may send to the server that transmitted the OS program to microcircuit SE, a message containing a log of the OS program installation. The microcircuit SE is then ready to receive customization data relating to a user of the microcircuit. The microcircuit SE may also receive one or more applications, each for enabling a transaction of a specific type with a terminal of a specific type.

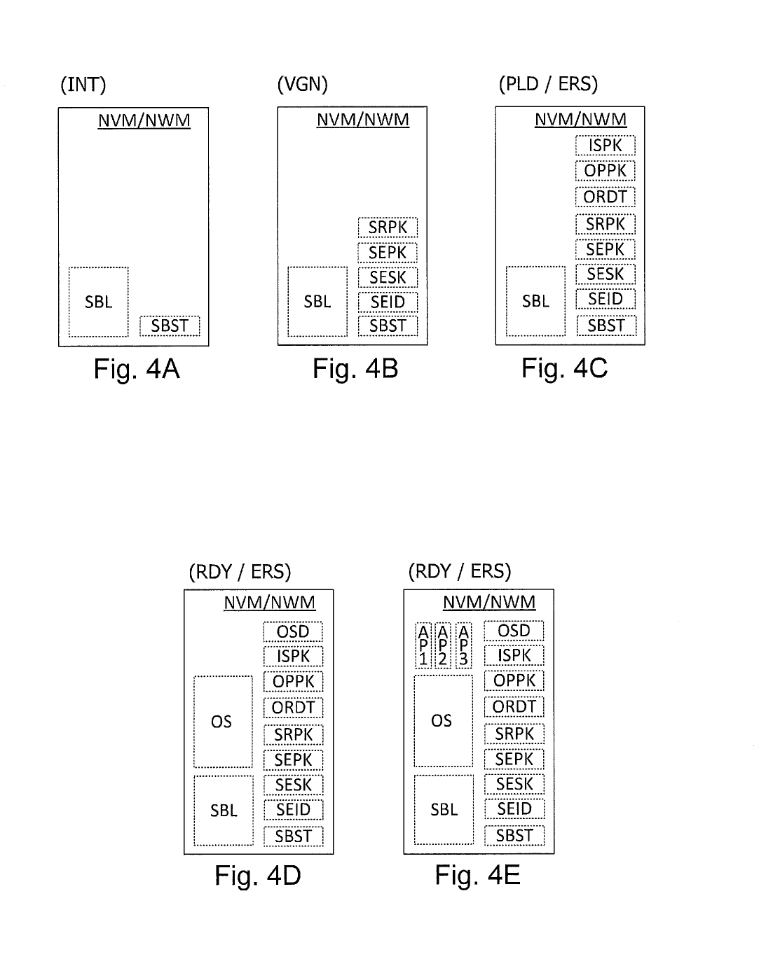

FIGS. 4A to 4E show the content of non-volatile memory NVM, and optionally NWM, of the microcircuit SE in the various states shown in FIG. 2. FIG. 4A shows the contents of the memories NWM, NVM in state INT, that is to say at the end of manufacturing of the microcircuit. In the NT state, the memory NVM/NWM simply contains the SBL program and the state variable SBST is initialized to INT. FIG. 4B shows the contents of memories NWM, NVM in state VGN. In the VGN state, the memory NVM/NWM further contains an identifier OIA of microcircuit SE, such as a serial number, a pair of public and private keys SEPK, SESK, as well as information relating to a server authorized to load profile data of an operating program OSPL in the non-volatile memory NVM of microcircuit SE. Information about the authorized server includes a public key SRSK and possibly an address SRVA or identifier of this server.

FIG. 4C shows the contents of memories NWM, NVM in the PLD state. In the PLD state, the NVM memory contains, in addition to the data of the VGN state, data ORDT relative to the operating program OS that may be loaded into the NVM memory, a public key OPPK of an entity authorized to load the OS program, and a public key of a vendor of the microcircuit SE. The data ORDT relating to the OS program include an identifier of the program, the size of the OS program and a start address for loading the program in the NVM memory, the data size of the OS program and a start address for loading the data into the NVM memory, integrity data for the program, such as a checksum, and possibly the date of loading the data into the NVM memory.

FIG. 4D shows the contents of memories NWM, NVM in the RDY state. In the RDY state, memory NVM contains, in addition to the data of the PLD state, the installed OS program and data OSD for the OS program. FIG. 4E shows the contents of memories NWM, NVM in the RDY state, after loading and installing applications AP1, AP2, AP3.

The memories NWM, NVM shown in FIGS. 4C-4E may also be in the ERS state if an authenticated erase command ERRQ has been sent to the microcircuit SE, but has not been processed yet.

Only the OS program, not the SBL program, may ensure loading and installing of applications AP1, AP2, AP3, and management of memories VM and NVM for the storage and manipulation of application data. Generally, only the OS program can manage memory space for application execution, by loading the executable code of an application to run in the VM memory, assigning the application a specific isolated execution space in memory, and ensuring an interface between the application and the hardware resources of the microcircuit SE, such as the communication interface ICM, a cryptographic coprocessor, and memories VM, NVM. It should be noted that the SBL program can in no way be considered as an operating program or system compared to the OS program that, in turn, cannot be considered as an application program compared to the SBL program. Indeed, once the OS program is installed (while the microcircuit SE is in the RDY state), the SBL program only performs, at start-up of the microcircuit SE, a set of tests (steps S1, S2) before handing over execution to the OS program. Therefore, the SBL program does not ensure loading the OS program in memory VM for execution, nor the interface between the OS program and hardware resources of the microcircuit SE, nor the allocation of a volatile memory space for the OS program execution.

According to an embodiment, the OS program has its own resources that are not shared with the SBL program. Thus, the OS program itself ensures the control of the interface circuits ICM and has cryptographic functions. If the processor PRC has an interruption vector table or exception vectors, the installation of the OS program reconfigures the table, with the exception of vectors corresponding to the power-on, initialization and reset signals PWO, RST, WRST.

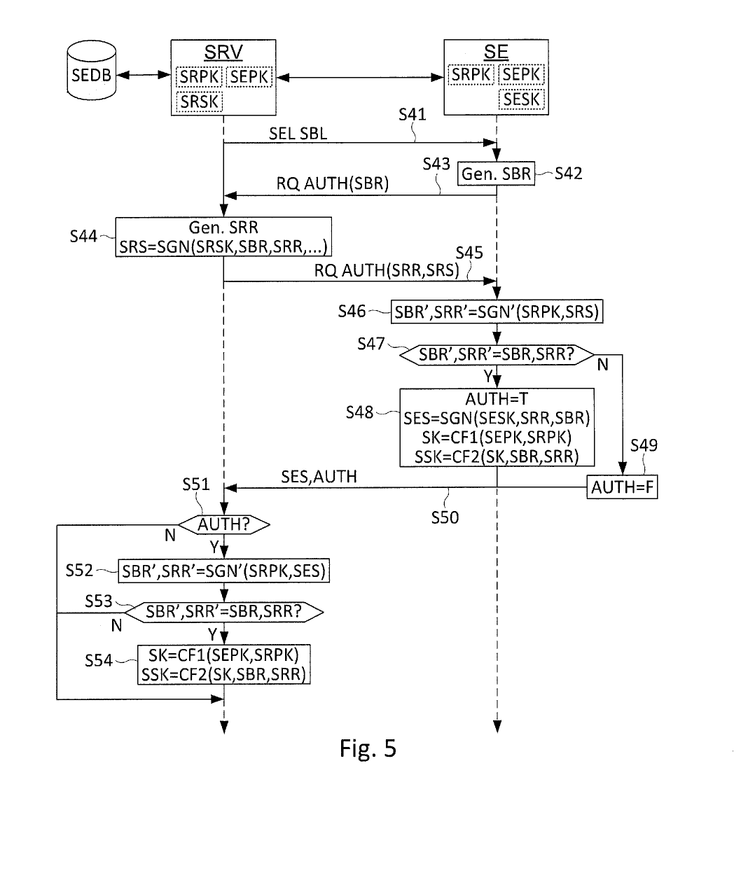

FIG. 5 shows steps of the authentication procedure performed in steps S5, S16 and S21. This procedure includes steps S41 to S54 performed by the microcircuit SE and server SRV. The microcircuit SE and server SRV may communicate with each other by any means, for example via a contact or contactless reader, to which the microcircuit SE can connect. The microcircuit SE may also be inserted into a mobile phone and communicate with the server SRV via a processor of the phone and a communication link using a communication interface of the phone (GSM/3G/LTE/USB/WIFI . . . ).

The server SRV holds the identifier SEID and the public key SEPK of the microcircuit SE, both of which may be stored in a database SEDB of identifiers for microcircuits in service. In step S41, the server SRV establishes a communication with the microcircuit SE and issues a command for selecting the SBL program. This command may conform to the APDU (Application Protocol Data Unit) protocol defined by the ISO 7816 standard. At step S42, the processor PRC of microcircuit SE generates a random number SBR. At step S43, the processor PRC transmits in response to server SRV an authentication request containing the number SBR. At step S44, the server SRV generates a random number SRR, and calculates a signature SRS using a cryptographic function SGN applied to the random number SBR received from the microcircuit SE and to the generated random number SRR, using a private key SRSK of the server SRV corresponding to the public key SRPK stored by the microcircuit SE. At step S45, the server SRV transmits to the microcircuit SE an authentication request containing the random number SRR and signature SRS. At step S46, the processor PRC applies to the received signature SRS a cryptographic function SGN′ corresponding to function SGN, using the public key SRPK of the server SRV. Under these conditions, the function SGN′ provides numbers SBR′ and SRR′. In step S47, the processor PRC compares the numbers SBR′ and SBR, and the numbers SRR′ and SRR. In steps S48 and S49, the processor PRC updates an authentication token AUTH based on the result of these comparisons. Step S48 is executed if the numbers SBR′ and SBR match and if the numbers SRR′ and SRR match, which means that the server SRV holds the private key SRSK corresponding to the public key SRPK stored by the microcircuit SE and has properly authenticated. At step S48, the processor PRC also calculates a signature SES using the function SGN on the numbers SBR and SRR, using its private key SESK. The processor PRC also generates a secret SK by applying a cryptographic function CF1 to the public keys SEPK and SRPK of the microcircuit SE and server SRV, and calculates a session key SSK by applying a cryptographic function CF2 to the secret SK and random numbers SBR and SRR. The function CF1 may be a Diffie-Hellman function, for example, applied to points of an elliptic curve in a finite field. The function CF2 may be an irreversible function such as a hash function, e.g. SHA-1. The step S50 is executed by the processor PRC following step S48 or S49. In step S50, the processor PRC transmits to the server SRV the authentication indicator AUTH and possibly signature SES.

At step S51, the server SRV receives the AUTH token and possibly the signature SES, and tests the value of the AUTH token. The server SRV performs the steps S52 to S54 only if the AUTH token indicates that the microcircuit SE has authenticated the server SRV. In steps S52, S53, the server SRV verifies the signature SES in the same manner as in steps S46 and S47. If the signature SES is wrong, the server SRV terminates the procedure, possibly by sending an error message to the microcircuit SE. Otherwise, the server SRV performs step S54 where it calculates the secret SK and the session key SSK, in the same manner as in step S48. The server SRV and the microcircuit are then ready to exchange data securely and confidentially with the session key SSK.

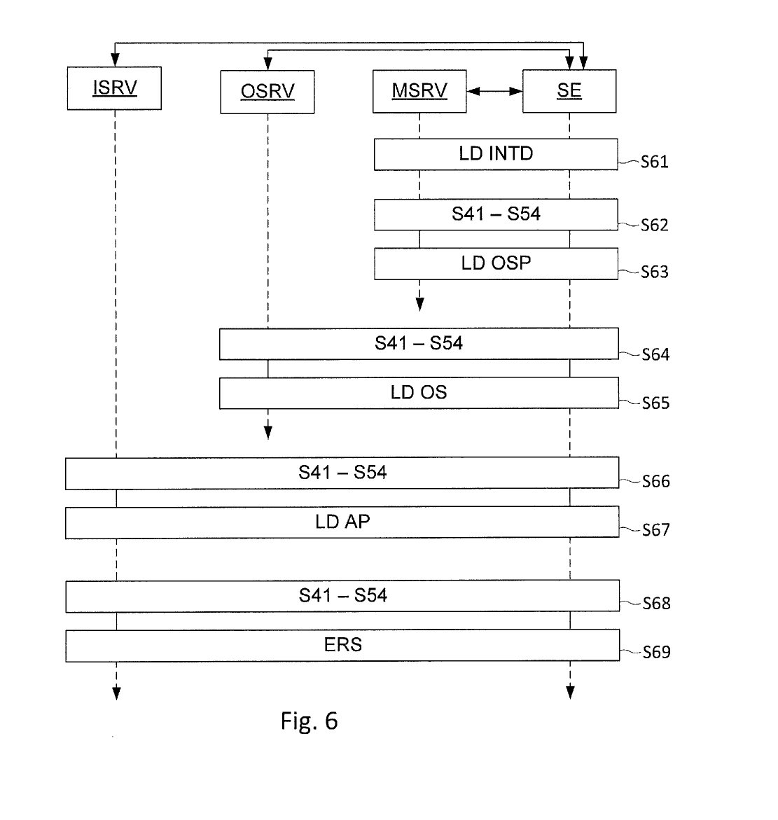

FIG. 6 shows steps S61 to S69 executed by the microcircuit SE under control of program SBL and by servers MSRV, OSRV and ISRV. Steps S61 to S63 are executed with the server MSRV that represents a server of the microcircuit manufacturer. Step S61 represents the loading of the initialization data of the SBL program (step S13). Step S61 enables the microcircuit SE to switch from state INT to state VGN. Step S61 may be followed by the transmission of a command or an authentication request. Step S62 represents a mutual authentication procedure performed by the server MSRV and the microcircuit SE, following the transmission to the microcircuit of an authentication request. If the authentication procedure is successful, the step S62 may be followed by step S63 for loading operating program profile data OSP. Step S63 switches the microcircuit SE in the PLD state.

The steps S64 and S65 may be performed by a vendor of the OS program, the OSP data including for this purpose the public key OPPK of the server OSRV that is authorized to load the OS program in the microcircuit SE. At step S64, the server OSRV and the microcircuit SE perform a mutual authentication. If the authentication procedure is successful, step S64 may be followed by step S65 for loading an operating program OS. If step S65 runs correctly, microcircuit SE switches to the RDY state.

Steps S66 to S69 may be performed by the microcircuit in the RDY state and by the server ISRV of a vendor of the microcircuit SE, whose public key ISPK is held in the data profile of the OS program. At step S66, the server ISRV and the microcircuit SE perform a mutual authentication. If the authentication procedure is successful, the step S66 may be followed by step S67 for loading one or more applications AP1, AP2, AP3, and data relating to the recipient of microcircuit SE. At step S68, the server ISRV and the microcircuit SE perform a new mutual authentication procedure. If the authentication procedure is successful, the step S68 may be followed by step S69 to execute an erase command transmitted by the server ISRV to the microcircuit SE. During the execution of the erase command, the microcircuit SE goes successively through the ERS and VGN states. In the VGN state, only the server MSRV whose public key is held in the initialization data of the SBL program may reload operating program profile data OSP (steps S62, S63). The microcircuit SE may then receive from another server referenced in the profile data loaded in step S63, an operating program (steps S64, S65) and application data (steps S66, S67).

It will be apparent to those skilled in the art that the present invention is susceptible to various alternatives and applications. In particular, the invention is not limited to executing an erase procedure of an operating system or program previously installed in the microcircuit. Indeed, although the deletion of such a program is envisaged, the microcircuit may operate throughout its life time with the same operating program.

The installation of applications in the microcircuit following the operating program installation is not required. The operating program installed in the microcircuit may itself include functions or applications allowing the microcircuit to perform certain transactions or to access a service.

Furthermore, according to the required degree of security, it may not be necessary to test the integrity of the operating program once it is installed in the microcircuit.

1. A method of loading an operating program in a secure microcircuit, comprising the steps of:
downloading and installing in the microcircuit a boot program, which is launched upon activation of the microcircuit,
loading into the microcircuit initialization data including a first public key,
performing a mutual authentication procedure between the microcircuit and a first server having a private key corresponding to the first public key, and if the mutual authentication is successful, loading from the first server operating program profile data holding a second public key,
performing a mutual authentication procedure between the microcircuit and a second server having a private key corresponding to the second public key, and if the mutual authentication is successful, loading an operating program from the second server and installing it in the microcircuit, and
activating the operating program when it is in the microcircuit.

2. The method of claim 1, comprising the steps of:
performing a mutual authentication procedure between the microcircuit and a third server having a private key corresponding to a third public key held in the operating program profile data, and
if the mutual authentication procedure is successful, loading an application from the third server and installing it in the microcircuit, and/or loading user data in the microcircuit.

3. The method of claim 1, comprising the steps of:
performing a mutual authentication procedure between the microcircuit and a third server having a private key corresponding to a third public key held in the operating program profile data, and
if the mutual authentication procedure is successful, running a command for erasing the operating program and operating program profile data in the microcircuit, wherein the erase command is transmitted to the microcircuit from the third server, and placing the microcircuit in a state where it is ready to receive new operating program profile data from the first server.

4. The method according to claim 1, wherein the operating program profile data and/or the operating program are transmitted in encrypted form using a secret key shared between the microcircuit and the first and/or second server during mutual authentication.

5. The method according to claim 1, comprising a step of receiving by the microcircuit a signal for enabling a control mode wherein the microcircuit can receive commands from a server, including an operating program erase command.

6. The method of claim 5, wherein the activation signal of the control mode includes a sequence of several reset signals received during a period of time.

7. The method according to claim 1, comprising a step of checking the integrity of the boot program upon start-up of the microcircuit.

8. The method according to claim 1, wherein the installation of the operating program in the microcircuit is followed by an integrity check of the installed operating program, wherein the operating program is erased from the microcircuit if the integrity check fails.

9. A secure microcircuit configured by a boot program for:
loading into the microcircuit initialization data comprising a first public key,
performing a mutual authentication procedure between the microcircuit and a first server having a private key corresponding to the first public key, and if the mutual authentication is successful, loading from the first server operating program profile data holding a second public key, and
performing a mutual authentication procedure between the microcircuit and a second server having a private key corresponding to the second public key, and if the mutual authentication is successful, loading an operating program from the second server and installing it in the microcircuit, and
activating the operating program when it is in the microcircuit.

10. The microcircuit according to claim 9, configured by the operating program for:
performing a mutual authentication procedure between the microcircuit and a third server having a private key corresponding to a third public key held in the operating program profile data, and
if the mutual authentication is successful, receiving an application from the third server and installing it in the microcircuit, and/or loading user data in the microcircuit.

11. The microcircuit according to claim 9, configured by the boot program for:
performing a mutual authentication procedure between the microcircuit and a third server having a private key corresponding to a third public key held in the operating program profile data, and
if the mutual authentication is successful, receiving from the third server and executing a command for erasing the operating program and the operating program profile data from the microcircuit, and placing the microcircuit in a state where it is ready to receive new operating program profile data from the first server.

12. The microcircuit according to claim 9, configured by the boot program for receiving a signal for enabling a control mode, wherein the microcircuit can receive commands from a server, including an operating program erase command.

13. The microcircuit according to claim 12, wherein the control mode enable signal includes a sequence of a number of reset signals received during a period of time.

14. The microcircuit according to claim 9, configured by the boot program to control the integrity of the boot program at start-up of the microcircuit.

15. The microcircuit according to claim 9, configured by the boot program to control the integrity of the operating program once it is installed, and to erase the operating program from the microcircuit if the integrity check failed.
